(19) United States
(12) Patent Application Publication
(10) Pub. No.: US 2021/0132686 A1
(43) Pub. Date: May 6, 2021

(54) STORAGE MEDIUM, AUGMENTED REALITY PRESENTATION APPARATUS, AND AUGMENTED REALITY PRESENTATION METHOD

(71) Applicant: SQUARE ENIX CO., LTD., Tokyo (JP)

(72) Inventor: Shigeru AWAJI, Tokyo (JP)

(73) Assignee: SQUARE ENIX CO., LTD., Tokyo (JP)

(21) Appl. No.: 17/091,985

(22) Filed: Nov. 6, 2020

Related U.S. Application Data
(63) Continuation of application No. PCT/JP2019/018762, filed on May 10, 2019.

(30) Foreign Application Priority Data
May 11, 2018 (JP) 2018-092457

(51) Int. Cl. G06F 3/01; G06T 11/00

(52) U.S. Cl. CPC G06F 3/011; G06T 11/00

(57) ABSTRACT

A storage medium records a program causes a computer to execute following process: acquiring the captured image; determining a position and an attitude of a viewpoint of the virtual space in which a virtual character is rendered; controlling to cause the virtual character to take an action; generating a character image by rendering the virtual character in which the action was reflected for the viewpoint; displaying a superimposed image generated by causing the character image to be superimposed on the captured image; and estimating a state of a user using the computer based on the virtual character after the action has been reflected and the viewpoint. An action that the virtual character is caused to take in accordance with the state of the user estimated as a result of having reflected the action in the virtual character is controlled.

### CROSS-REFERENCE TO RELATED APPLICATION(S)

This application is a continuation of International Patent Application No. PCT/JP2019/018762 filed on May 10, 2019, which claims priority to and the benefit of Japanese Patent Application No. 2018-092457 filed on May 11, 2018, the entire disclosures of which are incorporated herein by reference.

### TECHNICAL FIELD

The present disclosure relates to a storage medium, an augmented reality presentation apparatus, and an augmented reality presentation method, and more particularly, to a technique for performing augmented reality presentation via a display unit of a terminal carried by a user.

### BACKGROUND ART

There is a technique for presenting augmented reality by using wearable equipment.

In order to avoid complication of user operations, reproduction of virtual content to be presented in a superimposed manner on an object in real space existing at a corresponding position is started when wearable equipment approaches. See Japanese Patent Laid-Open No. 2015-037242.

### Technical Problem

In the technology described in Japanese Patent Laid-Open No. 2015-037242, control to reproduce the content is performed in accordance with the position of the wearable equipment, but there is no performance of control for estimating a state of the user and changing what reproduction content is or the like. Further, in Japanese Patent Laid-Open No. 2015-037242, in a case where an advertisement applied to the exterior of a bus or a train is targeted, corresponding content is reproduced when close to a user; however, Japanese Patent Laid-Open No. 2015-037242 does not disclose how presentation control is to be performed when it becomes distanced from the user.

At least one embodiment of the present disclosure was conceived in view of the above-described problems, and has as an object to provide a storage medium, an augmented reality presentation apparatus, and an augmented reality presentation method for estimating a state of a viewing user and providing augmented reality presentation in a suitable manner in relation thereto.

### SUMMARY

The present disclosure in its first aspect provides a non-transitory computer readable storage medium recording a program according to at least one embodiment of the present disclosure causes a computer comprising an image capturing unit and that is for performing a presentation of augmented reality by, in relation to a captured image obtained by a real space being captured by the image capturing unit, superimposedly displaying a character image in which a virtual character arranged in a virtual space associated with the real space is rendered, to execute a process of acquiring the captured image; a process of, based on a position and an attitude of the computer in the real space, determining a position and an attitude of a viewpoint of the virtual space in which the virtual character is rendered, a process of, based on the position and the attitude of the viewpoint, controlling to cause the virtual character to take an action; a process of generating a character image by rendering the virtual character in which the action was reflected for the viewpoint; a process of causing a display unit to display a superimposed image generated by causing the character image to be superimposed on the captured image; and a process of, as a result of having reflected an action in the virtual character, estimating a state of a user using the computer based on the virtual character after the action has been reflected and the viewpoint, wherein an action that the virtual character is caused to take in accordance with the state of the user estimated as a result of having reflected the action in the virtual character is controlled.

The present disclosure in its second aspect provides an augmented reality presentation apparatus that has an image capturing unit and is for performing a presentation of augmented reality by, in relation to a captured image obtained by a real space being captured by the image capturing unit, superimposedly displaying a character image in which a virtual character arranged in a virtual space associated with the real space is rendered, comprising: an acquisition unit configured to obtain the captured image; a determination unit configured to, based on a position and an attitude of the augmented reality presentation apparatus in the real space, determine a position and an attitude of a viewpoint of the virtual space in which the virtual character is rendered; a control unit configured to, based on the position and the attitude of the viewpoint, control to cause the virtual character to perform an action; a generation unit configured to generate the character image by, for the viewpoint, rendering the virtual character after having reflected an action; a display control unit configured to cause a display unit to display a superimposed image generated by causing the character image to be superimposed on the captured image; and an estimation unit configured to, as a result of having reflected an action in the virtual character, estimate a state of a user using the augmented reality presentation apparatus based on the virtual character after the action has been reflected and the viewpoint, wherein the control unit controls an action that the virtual character is caused to take in accordance with the state of the user estimated by the estimation unit as a result of having reflected the action in the virtual character.

The present disclosure in its third aspect provides an augmented reality presentation method for performing a presentation of augmented reality by, in relation to a captured image obtained by a real space being captured by an image capturing unit, superimposedly displaying a character image in which a virtual character arranged in a virtual space associated with the real space is rendered, comprising: an acquisition step of acquiring the captured image; a determination step of, based on a position and an attitude of a terminal comprising the image capturing means in the real space, determining a position and an attitude of a viewpoint of the virtual space in which the virtual character is rendered; a control step of, based on the position and the attitude of the viewpoint, controlling to cause the virtual character to perform an action; a generation step of generating the character image by, for the viewpoint, rendering the virtual character after having reflected an action; a display control step of causing a display unit to display a superimposed image generated by causing the character image to be superimposed on the captured image; and an estimation step of, as a result of having reflected an action in the virtual character, estimating a state of a user using the terminal based on the virtual character after the action has been reflected and the viewpoint, wherein in the control step, an action that the virtual character is caused to take is controlled in accordance with the state of the user estimated in the estimation step as a result of having reflected the action in the virtual character.

### Advantageous Effects

With such a configuration, according to at least one embodiment of the present disclosure, it is possible to estimate a state of a viewing user and to perform an augmented reality presentation in a suitable manner in relation thereto.

Other features and advantages of the present disclosure will become apparent from the following description with reference to the accompanying drawings. Note that in the accompanying drawings, the same or similar components are denoted by the same reference numerals.

### BRIEF DESCRIPTION OF THE DRAWINGS

The accompanying drawings are included in the specification, and constitute a part thereof, and illustrate the embodiments of the present disclosure, together with the description thereof, are used to explain the principles of the present disclosure.

FIG. 1 is a block diagram showing a functional configuration of an AR presentation terminal according to an embodiment of the present disclosure.

FIG. 2A is a diagram illustrating a real space and a virtual space by which an AR content viewing experience is provided according to an embodiment of the present disclosure.

FIG. 2B is a diagram illustrating a real space and a virtual space by which an AR content viewing experience is provided according to an embodiment of the present disclosure.

FIG. 2C is a diagram illustrating a real space and a virtual space by which an AR content viewing experience is provided according to an embodiment of the present disclosure.

FIG. 3A is a diagram illustrating a screen for on which an augmented reality presentation is performed in the AR presentation terminal according to an embodiment of the present disclosure.

FIG. 3B is a diagram illustrating a screen on which an augmented reality presentation is performed in the AR presentation terminal according to an embodiment of the present disclosure.

FIG. 3C is a diagram illustrating a screen on which an augmented reality presentation is performed in the AR presentation terminal according to an embodiment of the present disclosure.

FIG. 4 is a flowchart illustrating presentation processing executed in the AR presentation terminal according to an embodiment of the present disclosure.

FIG. 5 is a diagram exemplifying a data structure for action information managed in an action list in the presentation process according to an embodiment of the present disclosure.

FIG. 6A is a diagram illustrating a screen on which an augmented reality presentation is performed in the AR presentation terminal according to a second variation of the present disclosure.

FIG. 6B is a diagram illustrating a screen on which an augmented reality presentation is performed in the AR presentation terminal according to the second variation of the present disclosure.

### DESCRIPTION OF THE EMBODIMENTS

### Embodiments

Hereinafter, embodiments will be described in detail with reference to the accompanying drawings. Note that the following embodiments do not limit the invention according to the scope of the patent claims, and not all combinations of features described in the embodiments are essential to the invention. Two or more of the plural features described in the embodiments may be arbitrarily combined. In addition, the same or similar components are denoted by the same reference numerals, and redundant descriptions thereof will be omitted.

In an embodiment described below, an example will be described in which the present disclosure is applied to an AR presentation terminal 100 as an example of an augmented reality presentation apparatus, which is capable of presenting augmented reality (AR) by superimposing a computer graphics (CG) image onto a live-shot image obtained by performing image capturing. However, the present disclosure is applicable to any apparatus capable of presenting at least visual augmented reality by superimposing a predetermined image on a live-shot image. In the present specification, the term “real space” refers to a real three-dimensional space that a user can perceive without using the AR presentation terminal 100, the term “virtual space” refers to a three-dimensional space for CG rendering that is constructed in the AR presentation terminal 100, and “augmented reality space” refers to a space expressed by combining the real space and the virtual space and which is expressed by superimposing an image in which the virtual space is rendered on a live-shot image obtained by imaging the real space.

<Functional Configuration of AR Presentation Terminal>

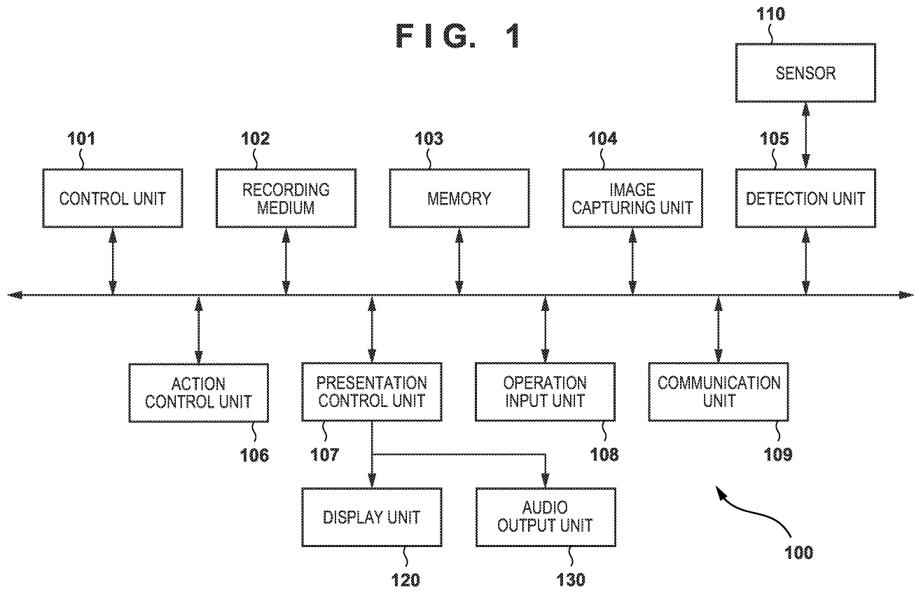

FIG. 1 is a block diagram showing a functional configuration of the AR presentation terminal 100 according to an embodiment of the present disclosure.

A control unit 101 is, for example, a CPU, and controls the operation of each block of the AR presentation terminal 100. The control unit 101 controls the operation of each block by reading out an operation program of each block or a program according to an AR presentation application stored in a recording medium 102 and loading and the program into a memory 103 and executing it.

The recording medium 102 is a non-volatile recording apparatus that may include, for example, a rewritable built-in memory of the AR presentation terminal 100, or an optical disk that can be read via an HDD or an optical drive. The recording medium 102 records not only an operation program of each block and a program related to an AR presentation application, but also information such as various parameters necessary for the operation of each block. It is assumed that various kinds of data used in the operation of the AR presentation application executed in the AR presentation terminal 100 of the present embodiment are also stored in the recording medium 102. The memory 103 is, for example, a volatile memory, and is used not only as a loading region for an operation program of each block and a program of an AR presentation application, but also as a storage region for temporarily storing intermediate data and the like output in the operation of each block.

An image capturing unit 104 is an image capturing apparatus unit having an image capturing element such as a CCD or a CMOS sensor, and the image capturing unit 104 functions as an external recognition unit of the AR presentation terminal 100 without being limited to obtaining a live-shot image used for AR presentation. The image capturing unit 104 captures an image of a subject present in the real world (real space) and outputs a captured image (live-shot image). Image capturing is performed intermittently, and while the AR presentation application is being executed, live-shot images are sequentially displayed on a display unit 120, which will be described later, so that a certain delay may occur, but the real space and the augmented reality space (real space+virtual space) can be viewed via the terminal.

A detection unit 105 applies predetermined image processing to the live-shot image outputted by the image capturing unit 104 to detect at which position in the real space the AR presentation terminal 100 is present and what attitude it is in. Prior to providing a viewing experience using the AR presentation application of the present embodiment, real space feature information to serve as a provision range is collected, and calibration for associating a virtual space with the real space is performed. Thus, the position and attitude of the AR presentation terminal 100 can be detected based on the feature information included in the live-shot image. Also, the detection unit 105 does not need to perform detection by applying image processing to all of live-shot images captured in successive frames, and may perform detection on the live-shot images captured at predetermined time intervals, and may compensate for this based on the sensor output of a sensor 110 which includes, for example, a gyro sensor, an acceleration sensor, or the like. Alternatively, the detection unit 105 may perform the detection with the sensor output of the sensor 110 alone, without using the image processing on the live-shot images.

An action control unit 106 performs control of an action of a virtual object to be presented in a superimposed manner on a live-shot image in the AR presentation application of the present embodiment. The virtual object presented by the AR presentation application is a character (AR character) whose appearance is formed by a three-dimensional model, and the action control unit 106 performs various control of actions such as movements and behavior to that the AR character is to be caused to take based on the position and attitude of the AR presentation terminal 100 and other parameters. In the present embodiment, an action taken by the AR character occurs over a plurality of frames, and includes not only an action generated by applying corresponding motion data to the three-dimensional model corresponding to the AR character, but also speech of a dialogue associated with the action or the situation. For simplicity, in the following description, it is assumed that the virtual object to be superimposed and presented on the live-shot image is only the AR character, but the implementation of the present disclosure is not limited to this.

A presentation control unit 107 handles control of presentation of various kinds of information to the user in the AR presentation terminal 100. Although the AR presentation terminal 100 according to the present embodiment has the display unit 120 which displays an image (an AR presentation screen, another OS menu screen, or the like) and an audio output unit 130 that outputs audio as a means for presenting various kinds of information to the user, it is needless to say that means for presenting information is not limited to these, and alternatives or additions are possible.

The presentation control unit 107 includes, for example, a rendering apparatus such as a GPU, and performs predetermined rendering processing when generating an AR presentation screen to be displayed on the display unit 120. More specifically, during execution of the AR presentation application, the presentation control unit 107 executes an appropriate an arithmetic operation on a three-dimensional model of the AR character based on the processing and commands performed by the control unit 101, and an action determined by the action control unit 106, and firstly renders an image according to the virtual space (an image in which only the AR character is presented). Then, the presentation control unit 107 generates an AR screen (a screen according to augmented reality space) that presents augmented reality by synthesizing an image according to the rendered virtual space and a live-shot image according to the real space. The generated AR screen is presented to the user by being output to and displayed on the display unit 120 provided in the AR presentation terminal 100. The display unit 120 is a display device of the AR presentation terminal 100 such as an LCD. In the present embodiment, in consideration of portability at the time of providing the viewing experience, the display unit 120 is built into the AR presentation terminal 100 and integrated with the AR presentation terminal 100, but implementations of the present disclosure are not limited to this, and it may be a display device that is connected detachably externally from the AR presentation terminal 100 by wire or wirelessly, for example.

The presentation control unit 107 includes a circuit for outputting/amplifying an audio signal such as a sound board or an amplifier, and performs predetermined processing when generating audio to be output from the audio output unit 130. Specifically, the presentation control unit 107 determines audio data to be simultaneously output based on audio data recorded in advance in the recording medium 102, for example, and converts this into an electrical audio signal (D/A conversion), and outputs it to the audio output unit 130, thereby performing audio output. The audio output unit 130 may be a predetermined speaker or the like, and outputs sound waves based on the input audio signal.

An operation input unit 108 is a user interface of the AR presentation terminal 100, such as a touch panel or a button. Upon detecting an operation input made by the user, the operation input unit 108 outputs a control signal corresponding to the operation input to the control unit 101.

A communication unit 109 is a communication interface for communicating with another apparatus included in the AR presentation terminal 100. The communication unit 109 is connected to, for example, another server present on the network by a predetermined communication method either by wired or wireless communication, and transmits and receives data. Configuration may be such that it is possible to receive the program of the AR presentation application, feature information used for detection, information of a scenario describing basic action transitions of the AR character, and the like from an external apparatus via the communication unit 109.

<AR Content Overview>

Hereinafter, an outline of AR content by which a viewing experience is provided involving presentation of augmented reality by an AR presentation application executed by the AR presentation terminal 100 of the present embodiment will be described.

<Space Setting>

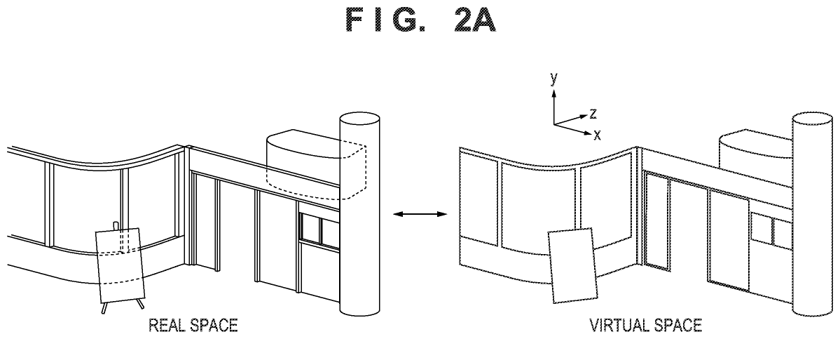

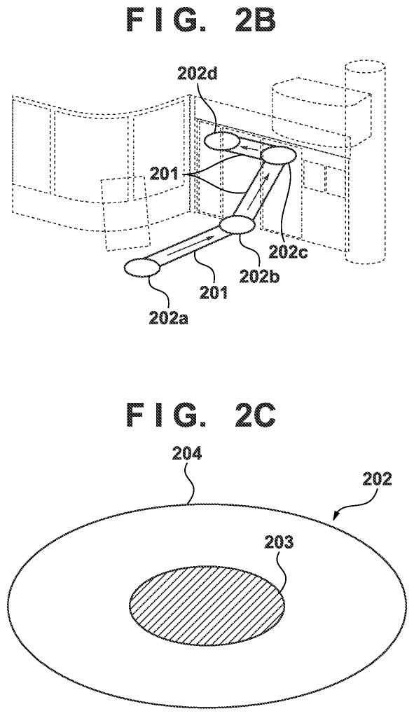

In the present embodiment, the AR content is content in which the AR character performs guidance from the store front to a predetermined position in the store in a single store. As shown in FIG. 2A, a virtual space associated with a real space range (a range around a store including a store front and a store inside) in which AR content can be presented is associated with the range.

As shown in FIG. 2A, with respect to static (non-movable) objects (real object) such as a wall, a signboard, stairs, a desk, or a chair placed in the real space, a three-dimensional object corresponding to the virtual space is arranged in order to suitably realize an occlusion representation according to the real object when superimposed on a live-shot image. Such three-dimensional objects are not made to be the target of rendering when an AR character which is also arranged in the virtual space is rendered, but they are made to be the target of depth value comparison for determining whether to or not to perform rendering so that a rendering expression in which the AR character is occluded is carried out when an object is closer to a viewpoint for which rendering is performed than the AR character. Further, it is assumed that these three-dimensional objects in the virtual space are arranged in accordance with a full size and arrangement relationship of the corresponding real objects, have the same shape as the real objects, and are size-adjusted by a predetermined scale.

It is assumed that the virtual space in which the virtual objects corresponding to the static real objects are arranged is configured in advance on the basis of a range in which the viewing experience is provided, and calibration is performed to associate the real space with the virtual space prior to execution of the AR presentation application. That is, before providing the viewing experience using the AR presentation terminal 100, translation and rotation of the coordinate system of the virtual space are set such that the arrangement of the real objects in the real space with respect to the image capturing unit 104 of the AR presentation terminal 100 matches the arrangement of the relevant virtual objects in the associated virtual space with respect to the viewpoint defined for the rendering in accordance with the position and attitude of the AR presentation terminal 100.

<Presentation of Augmented Reality>

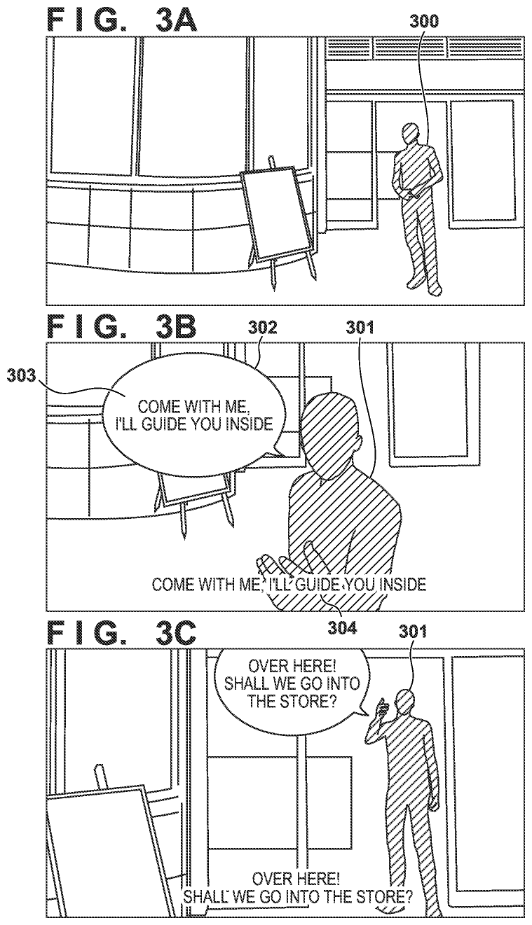

During execution of the AR presentation application, the image capturing unit 104 performs intermittent image capturing (moving image capturing), and the obtained live-shot images are sequentially displayed on the display unit 120, whereby a so-called through display showing the state of the real space is realized. When an AR character is included in an angle of view corresponding to the image capturing range of the live-shot image in the virtual space, as shown in FIG. 3A, by superimposing the image 300 of the character on the live-shot image, it is possible to present augmented reality to the user so that it seems as if the AR character were present in the real space. Here, a condition for superimposing the image of the AR character on the live-shot image may be that at least a part of the AR character is included within the angle of view of the virtual space corresponding to the imaging range, and the surfaces and features of the real space serving as a reference for the arrangement position of the AR character need not be included in the live-shot image.

In order to present augmented reality according to the AR content, it is necessary to allow the movement and attitude of the AR presentation terminal 100 to change in the real space, and more specifically, to allow the movement and attitude for the viewpoint for which the virtual space is rendered to change in synchronization with the change in movement and attitude of the image capturing unit 104. Therefore, the detection unit 105 detects the position and attitude of the AR presentation terminal 100 based on the live-shot images sequentially obtained by image capturing and on the sensor output of the sensor 110. When the position and the attitude of the AR presentation terminal 100 in the real space are specified, the position and the attitude (the line-of-sight direction) of the viewpoint for which the virtual space is rendered are also specified in accordance with therewith, and therefore, by rendering the virtual space based on that viewpoint and superimposing it on the live-shot image, it is possible to generate a screen in which augmented reality is presented without a sense of unnaturalness.

Note that, in the AR content of the present embodiment, there is a scenario whose theme is “waiting on the customer” in which the AR character walks along with the user and guides the user into the store, and therefore, it is assumed that the viewpoint in the virtual space functions equivalently to an object that would be recognized as the head (face+line-of-sight direction) of the user by the AR character. That is, the AR character performs an action such as talking toward the head of the user.

In addition, in the virtual space, when providing a series of viewing experiences related to AR content, as shown in FIG. 2B, a route 201 through which an AR character basically travels is preset. As described above, since the AR content of the present embodiment is content in which the AR character leads (guides) a user (a user of the AR presentation terminal 100) to a predetermined position (target) in the store, the route 201 connecting from an area 202a which is the start position of guidance to an area 202d which is the target position is set. As shown in the figure, in addition to points (area 202a and area 202d) corresponding to the start position and the target position, other points (area 202b and area 202c) may be provided in the route 201, and events that cause the AR character to perform a predetermined action are associated therewith. In the present embodiment, when the AR presentation terminal 100 enters (or approaches) a region in the real space corresponding to a respective area 202, an event for causing the character to perform an action occurs.

In order to present a suitable augmented reality, each area 202 is controlled not to be displayed in the augmented reality space so that the user cannot visually recognize its presence. In addition, in order to be able to present natural AR character behavior, the internal region of each area 202 is divided by concentric circles as shown in FIG. 2C, and an embodiment in which the actions of the AR character are controlled stepwise in accordance with the distance between the area center and the viewpoint is employed.

Assuming that the position at which the occurrence of the event defined for the area 202 is appropriate is an inner region 203 indicated by hatching in the figure, which is the central portion of the region, control of the action of the AR character is performed such that the user (the AR presentation terminal 100) is caused to enter the area. More specifically, when the AR presentation terminal 100 enters an outer region 204 defined outside the inner region 203, the AR character is caused to perform an action of leading the further advance to the inner region 203, and thereby can guide the user to an appropriate event occurrence. For example, when it is detected that the AR presentation terminal 100 has entered the outer region 204, the AR character, which was arranged in the center of the area 202, is caused to perform an action of “telling the user to stop” or “urging him or her to approach” so that a condition for the occurrence of an event defined for that area (entry of the AR presentation terminal 100 into the inner region 203) can be easily satisfied. Thus, as shown in the figure, the outer region 204 is configured to have a larger radial range than the inner region 203, and by controlling the action of the AR character when the AR presentation terminal 100 is in that region, it is possible to get the attention of the user in the periphery of the inner region 203 and guide him or her naturally to an appropriate position for the event to occur.

In other words, in the AR presentation application of the present embodiment, in each area 202, multi-step event occurrence is defined in accordance with the distance from the center so that the user is guided along a route. In this embodiment, a description will be given on the assumption that, for each area 202, the condition for occurrence of a series of actions of the AR character (calling-leading-unique event) for an experience of a unique event in the inner region 203 is satisfied when the AR presentation terminal 100 enters the outer region 204, but the implementation of the present disclosure is not limited to this. For example, configuration may be taken to control so that different unrelated events are assigned to each region partitioned by the concentric circles, and the condition for the occurrence of one or more events may be satisfied at the same time depending on how close the areas are, and at least one of these is caused to occur in accordance with a predetermined priority order or the like. In this case, information of the events whose occurrence condition is satisfied is sequentially stacked, and when the condition is satisfied, presentation is made in the form of an action of the AR character.

Further, in the present embodiment, the area 202 is configured to be circular (a precise circle) in this description, it but may also be any shape, such rectangular, polygonal, or the like. In particular, in consideration of the properties of the AR content with respect to the waiting-on-the-customer application, the shape of the area 202 may be an elliptical shape or a fan shape extending in the line-of-sight direction of the AR character.

The AR content may also provide a viewing experience involving an audible augmented reality presentation as well as a visual presentation. If the output from the audio output unit 130 is configured to allow a certain degree of sound image localization such as with stereo or surround settings, for example, an audio speech event of the AR character may be configured to utter speech when the user (the AR presentation terminal 100) is found to be (present) within the range of field of view of the AR character, and the user can be caused to focus on the audio generation source. That is, even if the AR character is not present within the angle of view displayed on the display unit 120 of the AR presentation terminal 100, the user can be made aware of the presence of the AR character by outputting sound. Therefore, the detection unit 105 may be configured to be able to specify a corresponding position in the virtual space from the feature information included in the live-shot image even when a real space in which the AR character is not present was captured.

Further, a method of specifying the position and attitude of the AR presentation terminal 100 by analysis of the live-shot image captured by the image capturing unit 104 or the like is employed in the present embodiment, but the position and attitude of the AR presentation terminal 100 may be specified by an external apparatus configured to be able to detect the AR presentation terminal 100 which is present in a predetermined real space range and supplied to the AR presentation terminal 100.

<AR Content Viewing Experience>

Next, the viewing experience of the AR content provided by the AR presentation application of the present embodiment will be described in more detail. For simplicity, a viewing experience that is to be provided, including an action that an AR character is caused to take in accordance with a positional relationship between a user and the AR character, will be described below, but it goes without saying that in reality the control of the action is performed in accordance with the positional relationship between the AR presentation terminal 100 and the AR character in the augmented reality space or the positional relationship between the AR character and the viewpoint corresponding to the position and attitude of the AR presentation terminal 100 in the virtual space.

In the AR presentation application of the present embodiment, for example, there is provided a viewing experience, started when the user approaches the AR character at the store front, of a scenario in which he or she is guided along a predetermined guidance line (the route 201 in FIG. 2B) from the store front to a predetermined position (a reception at which a real-world employee in charge of seating is present, or an empty seat) in the store, with the AR character leading the way of the user (or tagging along). Here, the route 201 is merely provided as a reference, and may be changed to some extent depending on the content of movements of the user.

The user waits in a queue, for example, in front of the store until his or her turn comes up, and then receives the AR presentation terminal 100 which is executing the AR presentation application from an employee when an empty seat becomes available in the store. After receiving the AR presentation terminal 100, the user can freely move about while viewing the augmented reality space via the display unit 120.

In response to the user approaching the area 202a defined as the start position (entering the outer region 204 of the area 202a) out of the areas 202 on the route 201 illustrated in FIG. 2B, the AR character faces the direction of the user and urges him or her to approach, and also, on the condition that he or she has approached (entered the inner region 203), starts to utter a script welcoming him or her to the store and guiding him or her into the store.

For example, as shown in FIG. 3B, the speech by the AR character is made by simultaneously presenting text 303 of the script content on a flat object (speech bubble object 302) configured as a speech bubble above the head of a AR character 301 in order to prevent the speech from being missed and to clarify which AR character is uttering the speech. In addition, since the speech bubble object 302 does not fit within the angle of view depending on the viewing direction, configuration may be such that a subtitle 304 having the same content as the text 303 may be always included in the screen.

When the guidance into the store is started, the AR character starts proceeding along the route 201 at a predetermined speed. During the progress along the route, the AR character time and again utters speech urging the user to follow him or her, as shown in FIG. 3C, or performs an action. The user then enters the store so as to follow having viewed this via the display unit 120.

When the AR character reaches the area 202 set on the route, the AR character waits nearby, and in response to the user entering the outer region 204 or the inner region 203 of that area, the AR character performs an action related to an event defined for the area.

Although the AR character moves along the route 201, the user may lose sight of the AR character. Therefore, in the present embodiment, the action control unit 106 estimates whether or not the user is “in a state in which he or she has lost sight of the AR character” based on the distance between the viewpoint and the AR character as a result of reflecting the action related to guidance (guide action) in the virtual space. In addition, the action control unit 106 controls to cause the action that the AR character is to be caused to take to change based on the estimation result.

That is, under the condition that the user has entered the area 202, control is performed such that the AR character not only takes a predetermined action for that area, but also takes a dynamic action according to the distance between the AR character and the user after the predetermined action. For example, in regards the event occurring in the area 202a, when the AR character moves along the route 201 toward the next area 202b, when the distance between the AR character and the user exceeds a predetermined threshold value, the action control unit 106 estimates that the state of the user is that he or she has lost sight of the AR character, and controls the action of the AR character, such that it turns back, stops, calls out, or returns on the route 201 to approach the user, in accordance with the distance.

<Presentation Process>

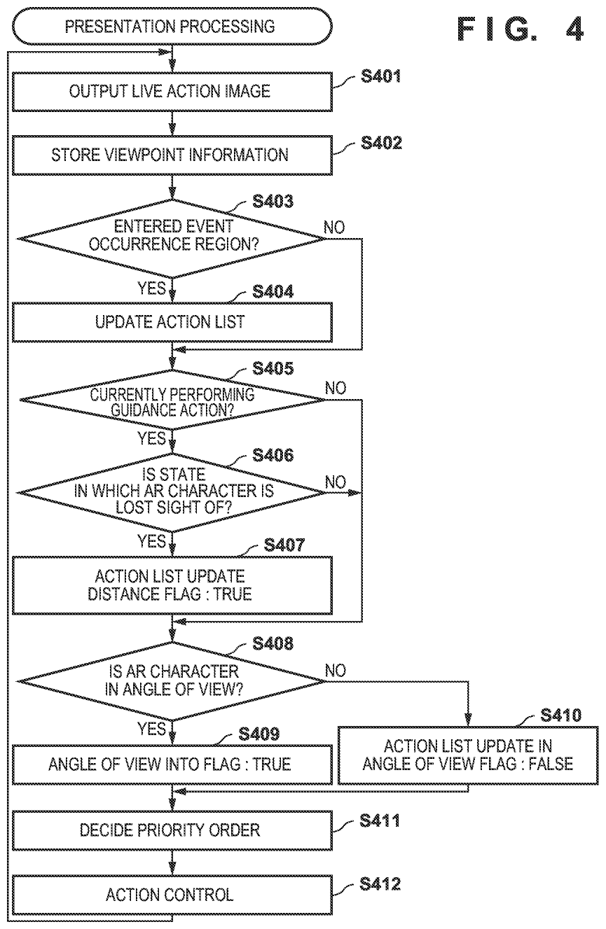

A specific process of presenting an AR character that is to be performed by the AR presentation application of the present embodiment having this kind of configuration will be described with reference to a flowchart of FIG. 4. The processing corresponding to the flowchart can be realized by the control unit 101 reading out a corresponding processing program stored in the recording medium 102, for example, loading it into the memory 103, and executing it. Note that this presentation process is described as being started when, for example, an operation input related to a request to present an AR content viewing experience is made in an executed AR presentation application. This presentation processing exemplifies processing performed for one frame according to an AR presentation, and is repeatedly performed for every frame for a continuous presentation.

Further, in this presentation process, when an event occurrence condition is satisfied, it is assumed that action control is basically performed so as to cause the AR character to take at least one of a motion or voice generation action determined in advance for the event, and so that the action is presented via the display unit 120 and the audio output unit 130. The information of each event may be held in the recording medium 102 as data for an AR presentation application, for example, and information describing an action including motion and voice utterances to be applied to an AR character when an event occurrence condition is satisfied is managed in association with an event ID for identifying each event.

In step S401, under the control of the control unit 101, the image capturing unit 104 captures an image related to the present frame, and outputs a live-shot image.

In step S402, under the control of the control unit 101, the detection unit 105 detects the position and attitude the AR presentation terminal 100 of based on the live-shot image captured in step S401 and the sensor output of the sensor 110. The detected position and attitude may be derived as, for example, a position (coordinates) in a world coordinate system of the virtual space and a rotation angle of each of the three axes centered at the position. The control unit 101 stores the detected information on the position and attitude of the AR presentation terminal 100 in the memory 103 as information on the viewpoint (viewpoint information) at which the virtual space is rendered.

In step S403, the control unit 101 determines whether the current viewpoint position has entered a region where the event is to occur of any of the areas defined on the route. The determination as to whether or not the region has been entered may be made based on whether or not a projection point is included in a region defined for the area when, for example, a three-dimensional position indicated by the viewpoint information is projected onto an XZ plane (a floor surface in the virtual world). When the control unit 101 determines that the current viewpoint position has entered an event occurrence region of any area, it moves the processing to step S404, and when it determines that it has not entered one, it moves the processing to step S405.

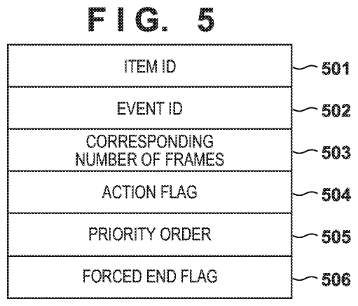

In step S404, under the control of the control unit 101, the action control unit 106 adds, based on the position and attitude of the viewpoint, information of an event whose occurrence condition is satisfied among events associated with the area that has been entered, to the action list being held in the memory 103, for example. In addition, the action control unit 106 deletes, from the action list, information of an event whose occurrence condition has ceased to be satisfied, from among the information of the events that have already been added to the action list. The action list may be a list in which information of events whose occurrence condition was satisfied is stacked, and information on one item of the list (action information) may be configured to have a data structure shown in FIG. 5, for example.

In the example of FIG. 5, action information managed as one item of the action list is associated with an item ID 501 for identifying an item, and may include an event ID 502 for identifying an event whose occurrence condition is satisfied, a corresponding number of frames 503 indicating the number of frames over which the state in which the occurrence condition is satisfied has continued, an action flag 504 (a boolean type. When true, an AR character is performing the corresponding action) for indicating whether or not an AR character is currently performing a corresponding action, and a priority order 505 for the corresponding action. Therefore, for events, among the events whose occurrence condition is satisfied in this step, that are already included in the action list, the action control unit 106 performs a process of incrementing the corresponding number of frames 503 of the action information already present in the list by one instead of a process of adding the action information to the action list. The information of the priority order 505 has a reference value determined in advance according to the type of event, and may input it as an initial value, but may be configured to be dynamically changeable according to the condition of the AR presentation terminal 100 or the AR character, as will be described later. Basically, in the action list, the priority order 505 related to the action that the AR character is currently being caused to take is set to a highest value (the action is prioritized).

Although details will be described later, the action that the AR character is caused to take has a predetermined duration before all the actions thereof will be finished. Therefore, basically, when there is an action that is currently being applied to the AR character, it is necessary to control the AR character not to reflect another action until the duration required for the action is completed in order to avoid the occurrence of unnatural behavior. On the other hand, as described above, it is desirable that an action that should caused to be taken when the state of the user is estimated (an action when it is estimated that the user has lost sight of the AR character after the guidance action was started) be delivered to the user as soon as possible. Accordingly, in the present embodiment, so that such an action be caused to be taken at a suitable timing, even if there is an action that is currently being applied, the action control unit 106 forcibly ends that action when it proceeds to a state in which no problem will arise even if it is interrupted, for example, and controls the AR character to take an action based on the estimation of the state of the user. Therefore, it is assumed that the action information further includes an action forced end flag 506 indicating that the action currently being applied to the AR character will be caused to finish at a predetermined break. The forced end flag 506 is, for example, boolean type information, and in a case where an initial value was added as false and then changed to true, control is performed so that when the corresponding action has proceeded until a predetermined break, a forcible end is caused irrespective of the priority order at that time, and the AR character is caused to take another action.

In step S405, the action control unit 106 determines whether or not the AR character is in a state of currently being caused to take a guiding action. The determination in this step may be made depending on whether or not the action information in which the action flag 504 included in the action list is true indicates the event ID 502 corresponding to the guidance action. If the action control unit 106 determines that the state is such that the AR character is currently being caused to take a guidance action, it moves the process to step S406, and if it determines that the state is not such that the guidance action is being caused to be taken, it moves the process to step S408.

In step S406, the action control unit 106, based on the information on the position of the AR character and the position of the viewpoint after the guidance action is applied in the virtual space, estimates whether or not the state of the user is that he or she has lost sight of the AR character. In this embodiment, for simplicity, only one threshold value for the distance between the viewpoint in the virtual space and the AR character is provided, and in a case where the threshold value has been exceeded, it is estimated that the state of the user is that he or she has lost sight of the AR character. Therefore, the action control unit 106 estimates the state of the user based on whether or not the distance between the viewpoint and the AR character is greater than or equal to a predetermined threshold value, as a result of the guiding action (an action involving movement along a route) started by the AR character in the processing of the previous frame. In a case where the action control unit 106 estimates that the user is in a state in which he or she has lost sight of the AR character, the process moves to step S407, and when it estimates that he or she is not in a state of in which he or she has lost sight of it, the process moves to step S408.

In step S407, under the control of the control unit 101, the action control unit 106 adds, to the action list, action information according to an event that is caused to occur in a situation where it is estimated that the user is in a state in which he or she has lost sight of the AR character as a result of the guidance action. The action control unit 106 sets to true a separation flag that is stored in the memory 103 indicating that the distance between the viewpoint and the AR character became greater than or equal to a predetermined threshold value due to the movement. Note that configuration is such that the separation flag is changed to false when the distance between the viewpoint and the AR character falls below the predetermined threshold value. When there is an action currently being applied to the AR character, the action control unit 106 changes the forced end flag 506 of the corresponding action information (the action information in which the action flag 504 is true) to true.

In the present embodiment, as described above, in a situation where the viewpoint and the AR character are separated from each other by greater than or equal to a threshold value as a result of the guiding action, the action control unit 106 adds to the action list action information for causing the AR character to take an action of approaching in the direction of the viewpoint, but the implementation of the present disclosure is not limited to this. In other words, in such a situation, in order to reduce the distance between the viewpoint and the AR character, it is sufficient to cause at least one of the AR presentation terminal 100 (the user himself/herself carries the AR presentation terminal 100) and the AR character to perform an action to encourage this. For example, even if the AR character itself does not move, it may be caused to perform an action such as to tell the user to move the AR presentation terminal 100 closer to the AR character.

In step S408, the action control unit 106 determines whether at least a part of the three-dimensional object of the AR character is included in the angle of view of the viewpoint for which the virtual space is rendered based on viewpoint information and arrangement information of the objects arranged in the virtual space under the control of the control unit 101. In a case where the control unit 101 determines that at least a part of the three-dimensional object of the AR character is included in the angle of view, it moves the processing to step S409, and in a case where it determines that it is not included, it moves the processing to step S410.

In step S409, the action control unit 106 sets the boolean type information (in-angle-of-view flag) stored in the memory 103 indicating that the three-dimensional object of the AR character is included in the angle of view of the viewpoint in the virtual space to true.

On the other hand, in a case where it is determined in step S408 that the three-dimensional object of the AR character is not included in the angle of view, in step S410, the action control unit 106 adds to the action list action information according to an event (an action for causing the user to focus on the AR character) cause to occur by the AR character not being captured in the angle of view of the viewpoint. The action control unit 106 sets the in-angle-of-view flag stored in the memory 103 to false. In the present embodiment, for simplicity, it is assumed that the addition of the action information and the change of the in-angle-of-view flag are performed in the frame in which it is determined that the AR character is not captured within the angle of view, but configuration may be taken such that this is determined to be satisfied when a corresponding state continues over a plurality of frames.

In step S411, the action control unit 106 determines the priority order of the action information included in the action list under the control of the control unit 101. The determination of the priority order may be performed based on each action information, separation flag, and in-angle-of-view flag included in the action list, and the priority order may be changed in accordance with the situation with the priority order 505 set in the frames thus far as a reference.

For example, in order to avoid unnatural behavior of the AR character, for an event in which the action flag 504 is true, that is, for an event in which an action corresponding to the AR character is progressing at least in the immediately preceding frame, the action control unit 106 sets the priority order 505 of the action information related to the event to be the highest if a motion or a voice defined for the action continues in the current frame. This process may be performed, for example, by updating the priority order 505 with a predetermined leading order value. On the other hand, when the forced end flag 506 of the action information according to the event in progress has been set to true, the priority order 505 is set to be the highest up until the frame to be forcibly terminated for the corresponding action, but when the frame to be forcibly terminated is passed, the priority order 505 is controlled to be lower than that of the action information related to another action.

If the separation flag is true, it is estimated that the user is in a state in which he or she has lost sight of the AR character, and therefore, if there is an event for which an action is currently in progress, the action control unit 106 then sets the priority order 505 of the action information corresponding to the separation to be higher. In this case, the forced end flag 506 of the action information according to the event that is in progress is set to true, and for example, an action corresponding to within several frames is forcibly terminated, and therefore the priority order 505 of the action information corresponding to the separation as the result of the guidance action is set to be highest after the forced termination. If there is no event for which an action is currently in progress, the action control unit 106 may immediately set the priority order 505 of the action information registered when the separation flag is set to true to be the highest.

In addition, since it is not desirable to cause the main event to advance in a state in which it is not being captured in the angle of view, when the in-angle-of-view flag is false, the action control unit 106 similarly sets the priority order 505 according to an event that is caused to occur by the AR character not being captured within the angle of view of the viewpoint to be high in accordance with whether it is an event for which an action is currently in progress. Note that in the present embodiment, an action that is caused to be taken when the user is estimated to be in a state in which he or she has lost sight of the AR character; that is, an action to be taken in response to a separation as the result of the guidance action, is made to include an action by which it is caused to be captured in the angle of view, and it is handled separately to an action to be taken in a case where the in-angle-of-view flag simply becomes false.

Further, in a case where there is an event in which an AR character has already been caused to perform a corresponding action, the action control unit 106 may perform a process of setting the priority order 505 of the action information to the lowest value or deleting the corresponding action information from the action list so that the same event does not occur.

Regarding the priority order of basic events, the action control unit 106 may set the priority order 505 to be, for example, an order of: an event for which the current action is in progress; then an event for eliminating a separation between the viewpoint and the AR character, then an event for causing the AR character to be captured within the angle of view; and then an event set for an area. In this case, when there are a plurality of events having the same classification, control may be performed so as to start from an event for which the condition for occurrence has been satisfied for the largest number of frames, with reference to the corresponding number of frames 503 of each action information.

In step S412, under the control of the control unit 101, the action control unit 106 performs action control of the AR character of this frame, based on the priority order set in step S411. More specifically, the action control unit 106 supplies the attitude information of the AR character and the information of the script and the audio in the present frame to the presentation control unit 107 to present them as appropriate. When presentation (screen, audio) related to the present frame is performed by the presentation control unit 107, the control unit 101 returns the process to step S401.

As described above, by virtue of the augmented reality presentation apparatus of the present embodiment, it is possible to estimate a state of a viewing user and to present augmented reality in a suitable manner in relation thereto.

[First Variation]

In the above described embodiment, it is described that under the condition that the distance between the viewpoint in the virtual space and the AR character exceeds a single predetermined threshold value as the result of the application of the guidance action, the user is in a state in which he or she has lost sight of the AR character. However, situations in which the viewpoint in the virtual space and the AR character are separated as the result of causing the AR character to perform the guidance action in this way are not limited to the situation in which the user loses sight of the AR character.

In the above-described embodiment in which a viewing experience is provided, since the user can freely move while carrying the AR presentation terminal 100, it is not necessarily the case that he or she will follow the AR character, for example, when he or she observes the outer appearance of the store front, takes a photograph, or the like. In addition, the situation of the user may vary, such as when the user progresses so as to overtake the AR character or moves in the wrong direction, or when progress becomes difficult due to some unexpected situation. Accordingly, the action control unit 106 may perform control so as to estimate the state of the user in consideration of not only the distance in the virtual space between the AR character and the viewpoint as a result the action being reflected but also the sensor output and the shooting direction of the AR presentation terminal 100, and cause the action to be performed by the AR character to be changed based on the estimation result.

For example, in a case where it can be determined that the viewpoint in the virtual space and the AR character are separated from each other beyond a predetermined threshold value and that the attitude of the AR presentation terminal 100 is substantially fixed to being oriented in a direction different from the direction of progress according to the guidance, the action control unit 106 may estimate that the user is in a state in which he or she is gazing at some object in the real space. In this case, the action control unit 106 may control the occurrence of events and actions so as to lead back to the guidance while causing the AR character to return to the route, and causing an event such as asking what are you looking at to occur.

For example, when a viewpoint exists in the direction of progress of the AR character in the route which was caused to move in the guidance action, that is, when the user moves to overtake the AR character, the action control unit 106 may estimate that the user is in a state in which he or she desires prompt guidance. In this case, after causing the AR character to progress along the route to the position of the viewpoint, the action control unit 106 may control the occurrence of events and actions so as to advance along the route at a speed faster than the route movement speed according to the guidance up until that point.

Also, in the above described embodiment, the description had a single predetermined threshold value, but the implementation of the present disclosure is not limited to this, and configuration may be taken to provide a plurality of threshold values for the distance occurring between the viewpoint and the AR character as the result of the movement along the route, and states of the user which can be estimated and corresponding actions may be provided in a stepwise manner.

[Second Variation]

In the above described embodiment, basically, it is determined whether an event is generated in accordance with whether the viewpoint approaches a preset area or with a distance between the viewpoint and the AR character, and it is determined whether the action information is to be registered in the action list, but the implementation of the present disclosure is not limited to this. For example, there is no need for the event occurrence condition to be limited to something that is determined in advance, and in a case where an image of a specific object ascertained by machine learning is detected in the live-shot image, or when geographical information of a real space with which a virtual space is associated is acquired, the action control unit 106 may perform control to cause an event of starting a conversation including a topic related to that object or region for the AR character.

For example, the specific object installed in the real space may be an event poster or a product poster posted on the wall of the store, or a product itself, or the like, and when these are detected, the action control unit 106 may add action information for causing the AR character to perform a talk related to the poster, product advertising, or a talk for guidance to the product. In such a case, even if an object is being captured in the angle of view, the user will not necessarily focus on it, and so configuration may be taken so as to cause the character to first take an action for encouraging focus on object, and then starting the action in a case where it is estimated attention is being paid thereto based on the sensor output of the sensor 110 or the like. Alternatively, it is also possible to determine whether or not the corresponding object is focused on by the sensor output of the sensor 110 or the like, and configuration may be taken to estimate a theme of interest or concern of the user, and reflect it in the subsequent action control.

Further, for example, when a store in which a viewing experience is provided is near the sea, a condition for occurrence of an event may be adaptively added or deleted, such as touching upon the topic of the sea, introducing the topic of the weather when the sky is captured in the angle of view, touching upon the topic of the weather when weather information has been received, or the like.

[Third Variation]

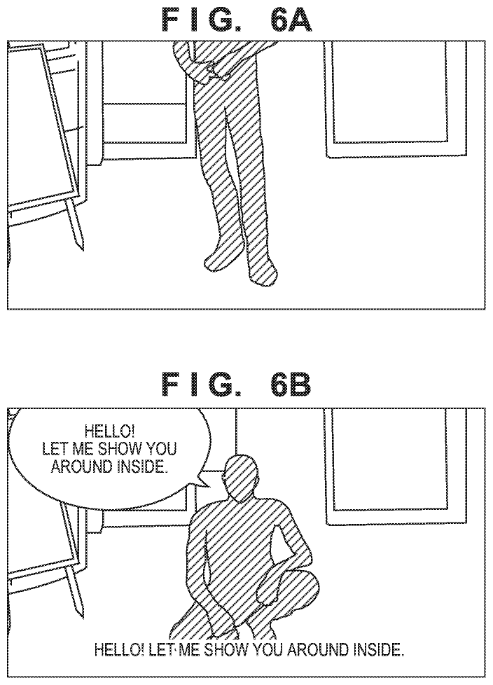

Incidentally, in an embodiment of providing the user with the viewing experience for the above-described waiting-on-the-customer application, the age and height of the user may vary. That is, even if the AR character height and the AR content details are configured on the assumption of use by an adult of average height, there is the possibility that a suitable experience will not be possible, depending on the user. For example, when a child who is short uses it, the AR presentation terminal 100 may always be maintained at a height of several tens of centimeters from the ground surface. Therefore, in a state where the AR presentation terminal 100 is kept horizontal, only the feet of the AR character are presented as shown in FIG. 6A, and there is a possibility that the AR content cannot be suitably understood. In other words, when the AR presentation terminal 100 is held so as to maintain an elevation angle equal to or greater than a threshold value in order that the face of the AR character be presented, the user will have difficulty confirming their feet and safety cannot be ensured, and since the necessary feature information will tend not to be included in the angle of view, there is a possibility that the presentation of the AR content cannot be stably presented.

Therefore, in the present variation, the action control unit 106 estimates what kind of person the user carrying the AR presentation terminal 100 is and controls to cause the action to change in response thereto. More specifically, the action control unit 106 estimates the height and age of the user based on the analysis of the live-shot image by the detection unit 105 and the sensor output related to the attitude of the AR presentation terminal 100, and performs action control so that the manner of guidance by the AR character is caused to change.

For example, it is assumed that a viewing experience involving augmented reality presentation is provided by using an AR character whose height is set to 170 cm and whose tone is set to friendly. When it is determined that the elevation angle is equal to or greater than a predetermined degree and the height of the AR presentation terminal 100 from the ground surface is low for an attitude changed so that the face of the AR character fits within the angle of view in response to a call from the AR character, the action control unit 106 estimates the user to be a short child. In this case, as shown in FIG. 6B, the action control unit 106 may change the action reference of the AR character, such as by making it crouch down to speak to the user, by setting tone to be polite, by slowing the walking speed, or the like. In addition, in the case where the surroundings are recognized and a product is introduced or the like as in the first variation, control may be performed to cause the target to be shifted to a product which is likely to be well received by a young customer. Similarly, when it is determined that the height of the AR presentation terminal 100 is higher than the AR character, specifically where a depression angle is indicated for an attitude changed so that the face of the AR character fits within the angle of view and it can be determined that the height from the ground surface is high, the action control unit 106 performs action control such as looking up to talk to the user.

### Other Embodiments

The present disclosure is not limited to the above-described embodiments, and various modifications and variations are possible without departing from the spirit and scope of the present disclosure. The augmented reality presentation apparatus according to the present disclosure can also be realized by a program that causes one or more computers to function as the augmented reality presentation apparatus. The program can be provided/distributed by being recorded on a computer-readable storage medium, or through an electronic communication line.

What is claimed is:

1. A non-transitory computer readable storage medium storing a program, the program causing a computer to execute functions comprising:
obtaining an image of a real space;
determining a position and an attitude of a viewpoint of a virtual space based on a position and an attitude of the computer in the real space with which the virtual space is associated;
controlling a virtual character to take an action based on the position and the attitude of the viewpoint;
generating a character image by rendering the virtual character taking the action in the virtual space;
superimposing the character image on the obtained image to generate a superposed image;
causing a display unit to display the superimposed image;
estimating a state of a user using the computer based on the virtual character and the viewpoint as a result of the action; and
controlling the virtual character to take another action in accordance with the estimated state of the user.

2. The storage medium according to claim 1, the functions further comprise:
if a distance between the virtual character and the viewpoint exceeds a predetermined threshold value as the result of the action,
estimating that a state of the user is a specific state; and
controlling the virtual character to take the other action that differs in accordance with the distance between the virtual character and the viewpoint.

3. The storage medium according to claim 2, wherein the action includes a movement within the virtual space,
the function includes:
controlling the virtual character to perform an action that reduces the distance if a distance between the virtual character and the viewpoint after the movement exceeds the predetermined threshold value.

4. The storage medium according to claim 3, wherein the action that reduces the distance is at least one of an action of the virtual character approaching the direction of the viewpoint in the virtual space or an action that prompts the user of the computer to cause movement of the computer in the real space.

5. The storage medium according to claim 2, wherein
a plurality of the predetermined threshold values are set, and
wherein estimating that the user is in the specific state includes estimating the state of the user in accordance with which threshold value of the a plurality of the predetermined threshold values the distance between the virtual character and the viewpoint exceeds as the result of the action.

6. The storage medium according to claim 5, wherein estimating that the user is in the specific state is further in accordance with the attitude of the computer.

7. The storage medium according to claim 1, wherein the functions further comprise detecting a position and an attitude of the computer in the real space based on the obtained image.

8. An augmented reality presentation apparatus comprising:
an image capturing unit configured to obtain an image of a real space;
a detection unit configured to determine a position and an attitude of a viewpoint of a virtual space based on a position and an attitude of the augmented reality presentation apparatus in the real space;
a control unit configured to control the virtual character to perform an action based on the position and the attitude of the viewpoint; and
a presentation control unit configured to generate the character image by, for the viewpoint, rendering the virtual character taking the action, and further configured to superimpose the character image on the capture image to generate a superimposed image; and
a display unit configured to display the superimposed image,
wherein the control unit is further configured to estimate a state of a user using the augmented reality presentation apparatus based on the virtual character and the viewpoint as a result of the action, and
wherein the control unit is further configured to control another action of the virtual character in accordance with the state of the user estimated.

9. An augmented reality presentation method comprising:
obtaining an image of a real space;
determining a position and an attitude of a viewpoint of the virtual space a based on a position and an attitude of a terminal in the real space;
controlling the virtual character to perform an action based on the position and the attitude of the viewpoint;
generating the character image by, for the viewpoint, rendering the virtual character;
superimposing the character image on the captured image to generate a superposed image;
displaying the superimposed image; and
estimating a state of a user using the terminal based on the virtual character after the action has been reflected and the viewpoint as a result of the action,
wherein controlling comprises controlling the virtual character to take another action in accordance with the state of the user.
